(19) United States
(12) Patent Application Publication
(10) Pub. No.: US 2010/0174582 A1
(43) Pub. Date: Jul. 8, 2010

(54) EFFICIENT AND EFFECTIVE USER TARGETED ADVERTISING THROUGH USER DRIVEN SELECTIONS AND USE OF VIDEO AND ELECTRONIC GAMES

(76) Inventors: Adam Makowka, Los Angeles, CA (US); Morgan Lee Keller, Los Angeles, CA (US); Dustin Beck, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/348,187

(22) Filed: Jan. 2, 2009

(51) Int. Cl. G06Q 30/00; G06Q 10/00; G06Q 50/00; G06F 15/16

(52) U.S. Cl. 705/10; 709/204; 705/14.12; 705/14.19; 705/14.55

(57) ABSTRACT

Systems, apparatus and methods for marketing through advertising video games are provided. In one embodiment, the method comprises presenting a list of the one or more products, services, brands or locations to one or more users; requesting the users select one or more products, services, brands or locations; receiving data indicating which of the one or more products, services, brands or locations the at users selected; presenting one or more video games to the users, presenting one or more instances of advertising related to the specific products, services, brands or locations selected by the users to the users; providing one or more incentives related directly to the specific products, services, brands or locations selected by the users to the users and receiving data from the users regarding their interest in, acceptance or rejection of the incentives provided to the users.

### FIELD OF THE DISCLOSURE

The present disclosure relates generally to the field of marketing and advertising, and more particularly, to the methods, systems and apparatus for providing novel marketing and advertising opportunities using both video games and video game related items.

### BACKGROUND

Advertising has always been an integral part of marketing methods used by companies to market their brands, products or services. To attract and maintain the attention and interest of viewers of the advertising, advertisers need to continually create new advertising methods and content that keeps viewers interested and engaged. Accordingly, advertisers continue to look for new and innovative ways to advertise their products, and, more importantly, to advertise more effectively and efficiently. New methods of targeted advertising have and are being devised to increase the return on investment (“ROI”) of advertising costs.

A new platform and opportunities for innovative and novel types of advertising have been created with the recent explosion of personal electronics, the internet and internet related content and services, and electronic media though the internet or otherwise. The internet and personal electronic devices are particularly well suited for response-oriented advertising. Response-oriented advertising is intended to generate a specific response or action from a user after exposure to an advertisement. Response-oriented advertisers focus on short-term benefit of advertising and seek to maximize the number of user responses per advertising dollar and demonstrate a proven and more efficient ROI.

One form of electronic media, the internet, makes it easier for users to view, react and respond to advertising. Unfortunately, excessive and often untargeted or miss-targeted advertising has dominated the internet, and annoyed many users of the internet. For example, pop-up or banner advertising while surfing internet or adds that correlate to words used in emails you send or receive while using a web based internet program (e.g. Hotmail or Gmail) are examples of excessive advertising that is ineffective and inefficient because it is often undesired and not of interest to the user and therefore creates a negative experience for the user. As a result, users are forced to either view or ignore advertisements that are neither desired nor needed. Other times, when the advertisements are linked to key words or demographics associated with the user, the user receive the same types of advertising narrowly focused on only a few topics or items. As a result, users become impatient and dissatisfied, and thus try to avoid or ignore advertisements. As a result, even when users receive or desire advertisements for a product or service they do want, they often try to avoid or ignore them as a result of prior excessive advertising, thus limiting the effectiveness of efficient advertising. Other types of advertising, such as SMS or text based messages, can be invasive and cost users money (e.g., standard text fees), which further creates a negative association with the advertising and/or advertiser.

Advertisers have tried to solve these and other drawbacks of mass electronic advertising through various methods, including but not limited to, sending targeted or loosely targeted advertising to users and creating various methods of matching users with advertising that the advertiser believes or hopes will get the response of the user. Unfortunately, these methods also have numerous drawbacks and often do not provide efficient or effective advertising. Some of those drawbacks include the user receiving at least some advertising that they are not interested in, the user ignoring or barely noticing the advertising provided and the user not seeing the advertising as providing anything of value and therefore having a negative experience or association with the advertising and/or the brand(s) it conveys.

In the light of the foregoing discussion, in order to improve the effectiveness and efficiency of advertising on the internet, there is a need for a new method, system and apparatus that provides better-targeted advertising information to a user. There is also a need for new methods, systems and apparatus that is able to select and present advertisements that have a high correlation to the users' needs, interests and behavior, thereby significantly increasing the probability of a successful advertisement. Furthermore, there is a need for new methods, systems and apparatus that provides advertising that is interesting to the user and causes the user to enjoy repeatedly viewing and appreciating related instances of advertising.

### SUMMARY OF THE DISCLOSURE

It is an object of the present disclosure to provide methods, systems and apparatus for highly effective and efficient marketing by providing targeted advertising information.

It is another object of the present disclosure to provide a method, system and apparatus that provides advertisements that are highly interesting for viewers of the advertisement.

It is yet another object of the present disclosure to provide a method and system for marketing through advertising video games.

It is yet another object of the present disclosure to provide methods, systems and apparatus for highly effective and efficient marketing where the user targets or selects the advertising, product, service, advertiser and/or incentive as opposed to the advertiser trying to target or select the user.

The objects of the present disclosure are achieved by, among other things, providing methods, systems and apparatus for marketing through advertising video games and video-game related items. In at least one embodiment, the marketing is done for one or more clients through one or more advertising video games, where the marketing is targeted to one or more users by the one or more clients. Further, the one or more advertising video games are one or more interactive media facilitating the marketing.

In one embodiment of the present disclosure, a method for presenting advertising related to one or more products, services, brands or locations to one or more users through one or more video games is provided. The method includes (1) presenting a list of the one or more products, services, brands or locations to one or more users on one or more visual displays, (2) requesting the one or more users select the one or more products, services, brands or locations using one or more computing devices, (3) receiving data indicating which of the one or more products, services, brands or locations the at least one or more users selected using the one or more computing device, (4) presenting one or more video games to the one or more users, the video game being presented to the one or more users for the user to interact with the one or more video game, (5) presenting one or more instances of advertising related to the specific products, services, brands or locations selected by the one or more users to one or more users, (6) providing one or more incentives related directly to the specific products, services, brands or locations selected by the one or more users to the one or more users; and (7) receiving data from the one or more users regarding interest in, acceptance or rejection of the one or more incentives provided to the one or more users.

In one aspect of the present disclosure, the advertising presented includes at least part of or a depiction of the one or more products, services, brands or locations selected by the one or more users and is incorporated into the one or more video games presented to the one or more users.

In another aspect of the present disclosure, the one or more video games comprise one or more of a sweepstakes and a game.

In yet another aspect of the present disclosure, the one or more incentives comprises one or more of a discount coupon, merchandise information, an existing offer, an advertisement material, a logo, a copyright, a trademark, an impression. a discount, a prize, information about new products or services and a link to another website or file which offers one or more of a discount coupon, merchandise information, an existing offer, an advertisement material, a logo, a copyright, a trademark, an impression, a discount and a prize, information about new products or services.

In yet another aspect of the present disclosure, the one or more incentives are sent through one or more of a hyperlink, a webpage, an email, a short messaging service (SMS) message, a barcode, a Multimedia Message (MMS), a visual display, a computing device and a phone call.

In another embodiment of the present disclosure, the method further includes providing a blog on a server for interaction of the one or more users with the other one or more users, the blog containing one or more instances of advertising directly related to one or more products, services, brands or locations selected by the one or more users.

In yet another embodiment of the present disclosure, the method further includes tracking the one or more instances of advertising presented to the one or more users and presenting new or additional instances of advertizing based on data from the one or more users regarding interest in, acceptance or rejection of the one or more incentives provided to the users.

In yet another aspect of the present disclosure, the one or more incentives related directly to the specific products, services, brands or locations selected by the one or more users receiving the incentive is provided upon the one or more users completing a task provided by the video game, the one or more incentives being a discount coupon, a redemption code and/or a rebate.

In yet another embodiment of the present disclosure, the method further includes storing the one or more incentives on a storage medium and allowing the one or more users access to the stored incentives and accumulate the stored incentives until the incentives are redeemed or expired.

In yet another aspect of the present disclosure, the one or more incentives are redeemed at website of the company or group providing the specific products, services or brands selected by the one or more users.

In yet another embodiment of the present disclosure, the method further includes providing information of the user to the selected client, the information being gathered from interaction of the user with the advertising video games.

In yet another embodiment of the present disclosure, the method further includes requesting that the one or more users create an account having a username and password prior to providing one or more incentives to the one or more users.

In yet another embodiment of the present disclosure, a system for marketing one or more clients through one or more video games containing advertising related to the one or more clients, the marketing being targeted to one or more users of the one or more video games by the one or more clients is provided. The system includes (a) at least one computer server having an interface for communication over a computer network, (b) a first presentation module, the first presentation module presenting a list of at least one of the one or more clients and products, services and brands associated with the one or more clients, the list being presented to one or more users of the one or more video games, (c) a selection module, the selection module requesting selection of at least one of the one or more clients and products, services and brands associated with the one or more clients and receiving data regarding the of at least one of the one or more clients and products, services and brands associated with the one or more clients selected by the one or more users, the selection being requested to the one or more users of the one or more video games, (d) a second presentation module, the second presentation module presenting the one or more video games containing one or more advertisements related to the one or more clients and products, services and brands associated with the one or more clients selected by the one or more users, (e) a game module, the game module providing the one or more users with interaction with the one or more video games, the one or more video games being presented to the one or more users for interaction with the one or more users and (f) a marketing module, the marketing module marketing the selected client by sending one or more marketing messages to the one or more users.

In yet another embodiment of the present disclosure, the system further includes a login module, the login module logging-in the one or more users.

In yet another embodiment of the present disclosure, the system further includes a reward module, the reward module providing one or more rewards to the one or more users upon completing a task provided by the at least one video game, the one or more rewards being selected from one of a discount coupon, a redemption code and a rebate.

In yet another embodiment of the present disclosure, the system further includes a track module, the track module tracking the one or more advertisements delivered on behalf of the selected client, the one or more impressions constituting the one or more marketing messages.

In yet another embodiment of the present disclosure, the system further includes an information module, the information module providing information of the user to the selected client, the information being gathered from interaction of the user with the advertising video game.

In yet another embodiment of the present disclosure, a computer program product for use with a computer is provided. The computer program product includes a computer usable medium having computer readable program code embodied therein for marketing one or more clients through one or more video games containing advertisements related to the one or more clients, the marketing being targeted to one or more users by the one or more clients, the one or more video games being one or more interactive media facilitating the marketing. The computer program code (a) presents a list of at least one of a list of one or more clients and products, services and brands associated with the one or more clients, the list being presented to the one or more users, (b) requests selection of at least one of the products, services and brands associated with the one or more clients; the selection being requested to at least one of the one or more users, (c) presents at least one video game of the one or more video games to the one or more users, the at least one video game containing advertising images related or corresponding to the at least one clients and products, services and brands associated with the one or more clients, (d) provides interaction with one of the at least one advertising video game, the advertising video game being presented to the user for the interaction, and markets the selected client, the marketing being done by sending one or more marketing messages based on the interaction with the advertising video game of the selected client.

In yet another embodiment of the present disclosure, a method for marketing one or more clients through one or more video games is provided. The method includes (a) providing a website hosted by the at least one computer containing a microprocessor in communication with the computer network, (b) presenting a list of the one or more companies, brands, products, locations and services on the website, the list being presented to the one or more users for selection by the user, (c) requesting selection of one of the one or more companies, brands, products, locations and services; the selection being requested to a user of the one or more users through the website, (d) presenting at least one video game of the one or more video games on the website, the at least one video game containing advertising corresponding to the selected one or more companies, brands, products, locations and services, (e) providing the one or more users with interaction with at least one video game, the video game being presented to the user for the interaction through the website and (f) marketing the selected client by sending one or more marketing messages or advertisements based on the one or more users interaction with the video game provided through the website.

In yet another embodiment of the present disclosure, a method for marketing the products or services of one or more clients through one or more video games, the marketing being targeted to one or more users by the one or more clients is provided. The method includes (a) providing at least one server containing a microprocessor in communication with a computer network, (b) presenting a list of the one or more clients or products, the list being presented to the one or more users by the at least one server, (c) requesting selection of one of the one or more clients or products by the at least server; the selection being requested to a user of the one or more users, (d) presenting at least one video game of the one or more video games by the at least one server, the at least one video game corresponding to the selected one or more clients or products, (e) providing interaction with one of the at least one video game by the at least one server, the video game being presented to the one or more users for interaction with the one or more users; and (f) marketing the selected client, the marketing being done by sending one or more marketing messages corresponding to the selected client or products by the at least one server.

In yet another embodiment of the present disclosure, the method for marketing the one or more clients through the one or more advertising video games includes presenting a list of the one or more clients, where the list is presented to the one or more users. Further, the method includes requesting selection of one of the one or more clients, where the selection is requested to a user of the one or more users. The method further includes presenting at least one advertising video game of the one or more advertising video games, where the at least one advertising video game corresponds to the selected client. The method further includes providing interaction with one of the at least one advertising video game. Finally, the method includes marketing the selected client, where the marketing is done by sending one or more marketing messages based on the interaction of the user with the advertising video game of the selected client.

In another embodiment of the present disclosure, a system for marketing the one or more clients through the one or more advertising video games is provided. The system includes a first presentation module for presenting a list of the one or more clients, where the list is presented to the one or more users. Further, the system includes a selection module for requesting selection of one of the one or more clients, where the selection is requested to a user of the one or more users. The system further includes a second presentation module for presenting at least one advertising video game of the one or more advertising video games, where the at least one advertising video game corresponds to the selected client. The system further includes a game module for providing interaction with one of the at least one advertising video game. Finally, the system includes a marketing module for marketing the selected client by sending one or more marketing messages based on the interaction of the user with the advertising video game of the selected client.

In yet another embodiment of the present disclosure, a method for presenting advertising related to one or more products, services, brands or locations to one or more users through one or more video games is provided. The method includes (1) presenting a list of the one or more products, services, brands or locations to one or more users, the list being presented to the one or more users on one or more computing devices, (2) requesting selection of one of the one or more products, services, brands or locations; the selection being requested to at least one user of the one or more users, (3) receiving data indicating which of the one or more products, services, brands or locations the at least one user selected (4) presenting at least one video game to the at least one user, (5) providing the at least one user interaction with one of the at least one video game, the video game being presented to the at least one user for the interaction, (6) presenting more than one instance of advertising to the at least one user related directly to the specific products, services, brands or locations selected by the at least one user; based on the interaction of the at least one user with the video game, (7) providing the at least one user with one or more incentives related to the specific products, services, brands or locations selected by the user and receiving data from the at least one user regarding interest in, acceptance or rejection of the one or more incentives provided to the at the at least one user.

### BRIEF DESCRIPTION OF THE DRAWING

The above, and other embodiments of the present disclosure, may be more fully understood from the following detailed description taken together with the accompanying drawing wherein similar reference characters refer to similar elements and in which:

FIG. 1 illustrates an environment in which the various embodiments of the disclosure can be practiced.

FIG. 2 shows a flowchart for marketing one or more clients through one or more advertising video games, in accordance with an embodiment of the present disclosure.

FIG. 3 shows a flowchart for marketing one or more clients through one or more advertising video games, in accordance with another embodiment of the present disclosure.

FIG. 4 illustrates the system for marketing one or more clients through one or more advertising video games, in accordance with an embodiment of the present disclosure.

FIG. 5 illustrates the system for marketing one or more clients through one or more advertising video games, in accordance with another embodiment of the present disclosure.

FIGS. 6a, 6b and 6c illustrates an example of the user-interface provided by the system for marketing one or more clients through one or more advertising video games, in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail the particular method and system for marketing through advertising video games in accordance with an embodiment of the present disclosure, it should be observed that the present disclosure includes combinations of method steps and system or apparatus components related to marketing though advertising video games.

The present disclosure provides methods, systems and apparatus for marketing through advertising video games and video game related items. More specifically, in one embodiment methods and systems for marketing one or more clients to one or more users through one or more advertising video games is provided. A list of the one or more clients is presented to the one or more users. Subsequently, one of the one or more clients is selected by a user. Thereafter, at least one advertising video game of the one or more advertising video games is presented to the user. The at least one video game corresponds to the selected client. Subsequently, interaction is provided with one of the at least one advertising video game selected by the user. Finally, the selected client is marketed by sending to the user one or more marketing messages corresponding to the selected client.

In another embodiment of the present disclosure, a method for presenting advertising related to one or more products, services, brands or locations to one or more users through one or more video games is provided. The method includes (1) presenting a list of the one or more products, services, brands or locations to one or more users on one or more visual displays, (2) requesting the one or more users select the one or more products, services, brands or locations using one or more computing devices, (3) receiving data indicating which of the one or more products, services, brands or locations the at least one or more users selected using the one or more computing device, (4) presenting one or more video games to the one or more users, the video game being presented to the one or more users for the user to interact with the one or more video game, (5) presenting one or more instances of advertising related to the specific products, services, brands or locations selected by the one or more users to one or more users, (6) providing one or more incentives related directly to the specific products, services, brands or locations selected by the one or more users to the one or more users; and (7) receiving data from the one or more users regarding interest in, acceptance or rejection of the one or more incentives provided to the one or more users.

It should be appreciated that the products, services, brands or locations presented can be any product, service, brand or location that the advertiser wants presented for whatever purpose. For example, an advertiser wanting to advertise tanning lotion might present the names of locations of area where there is a large market or could be a large market for their goods and/or services (e.g., cities with lots of sun where tanning is popular). It should also be appreciated a visual display includes but are limited to any device that allows the user to view the list of the one or more products, services, brands or locations, examples of which include but are not limited to a monitor, video screen, PDA and television. Examples of the one or more computing devices include, but are not limited to, a general purpose or specialty computer, a laptop, a PDA, a mobile phone, a computer readable medium, a hard drive and an embedded microprocessor and an interactive kiosk or monitor.

It should also be appreciated that the video game presented can be any video game that the user might enjoy, from a simple slot machine to a more complicated action/adventure/role-playing game.

In one aspect of the present disclosure, the advertising presented includes at least part of or a depiction of the one or more products, services, brands or locations selected by the one or more users and is incorporated into the one or more video games presented to the one or more users.

In another aspect of the present disclosure, the one or more video games comprise one or more of a sweepstakes and a game.

In yet another aspect of the present disclosure, the one or more incentives comprises one or more of a discount coupon, merchandise information, an existing offer, an advertisement material, a logo, a copyright, a trademark, an impression. a discount, a prize, information about new products or services and a link to another website or file which offers one or more of a discount coupon, merchandise information, an existing offer, an advertisement material, a logo, a copyright, a trademark, an impression, a discount and a prize, information about new products or services. Accordingly, it should be appreciated that the incentive provided can be anything well known in the art that the one or more users would be interested in.

In yet another aspect of the present disclosure, the one or more incentives are sent through one or more of a hyperlink, a webpage, an email, a short messaging service (SMS) message, a barcode, a Multimedia Message (MMS), a visual display, a computing device and a phone call. It should be appreciated that other well-known methods of providing the incentive are also within the scope of the present disclosure.

In another embodiment of the present disclosure, the method further includes providing a blog on a server for interaction of the one or more users with the other one or more users, the blog containing one or more instances of advertising directly related to one or more products, services, brands or locations selected by the one or more users.

In yet another embodiment of the present disclosure, the method further includes tracking the one or more instances of advertising presented to the one or more users and presenting new or additional instances of advertizing based on data from the one or more users regarding interest in, acceptance or rejection of the one or more incentives provided to the users.

In yet another aspect of the present disclosure, the one or more incentives related directly to the specific products, services, brands or locations selected by the one or more users receiving the incentive is provided upon the one or more users completing a task provided by the video game, the one or more incentives being a discount coupon, a redemption code and/or a rebate.

In yet another embodiment of the present disclosure, the method further includes storing the one or more incentives on a storage medium and allowing the one or more users access to the stored incentives and accumulate the stored incentives until the incentives are redeemed or expired.

In yet another aspect of the present disclosure, the one or more incentives are redeemed at website of the company or group providing the specific products, services or brands selected by the one or more users.

In yet another embodiment of the present disclosure, the method further includes providing information of the user to the selected client, the information being gathered from interaction of the user with the advertising video games.

In yet another embodiment of the present disclosure, the method further includes requesting that the one or more users create an account having a username and password prior to providing one or more incentives to the one or more users.

In yet another embodiment of the present disclosure, a system for marketing one or more clients through one or more video games containing advertising related to the one or more clients, the marketing being targeted to one or more users of the one or more video games by the one or more clients is provided. The system includes (a) at least one computer server having an interface for communication over a computer network, (b) a first presentation module, the first presentation module presenting a list of at least one of the one or more clients and products, services and brands associated with the one or more clients, the list being presented to one or more users of the one or more video games, (c) a selection module, the selection module requesting selection of at least one of the one or more clients and products, services and brands associated with the one or more clients and receiving data regarding the of at least one of the one or more clients and products, services and brands associated with the one or more clients selected by the one or more users, the selection being requested to the one or more users of the one or more video games, (d) a second presentation module, the second presentation module presenting the one or more video games containing one or more advertisements related to the one or more clients and products, services and brands associated with the one or more clients selected by the one or more users, (e) a game module, the game module providing the one or more users with interaction with the one or more video games, the one or more video games being presented to the one or more users for interaction with the one or more users and (f) a marketing module, the marketing module marketing the selected client by sending one or more marketing messages to the one or more users.

In yet another embodiment of the present disclosure, the system further includes a login module, the login module logging-in the one or more users.

In yet another embodiment of the present disclosure, the system further includes a reward module, the reward module providing one or more rewards to the one or more users upon completing a task provided by the at least one video game, the one or more rewards being selected from one of a discount coupon, a redemption code and a rebate.

In yet another embodiment of the present disclosure, the system further includes a track module, the track module tracking the one or more advertisements delivered on behalf of the selected client, the one or more impressions constituting the one or more marketing messages.

In yet another embodiment of the present disclosure, the system further includes an information module, the information module providing information of the user to the selected client, the information being gathered from interaction of the user with the advertising video game.

In yet another embodiment of the present disclosure, a computer program product for use with a computer is provided. The computer program product includes a computer usable medium having computer readable program code embodied therein for marketing one or more clients through one or more video games containing advertisements related to the one or more clients, the marketing being targeted to one or more users by the one or more clients, the one or more video games being one or more interactive media facilitating the marketing. The computer program code (a) presents a list of at least one of a list of one or more clients and products, services and brands associated with the one or more clients, the list being presented to the one or more users, (b) requests selection of at least one of the products, services and brands associated with the one or more clients; the selection being requested to at least one of the one or more users, (c) presents at least one video game of the one or more video games to the one or more users, the at least one video game containing advertising images related or corresponding to the at least one clients and products, services and brands associated with the one or more clients, (d) provides interaction with one of the at least one advertising video game, the advertising video game being presented to the user for the interaction, and markets the selected client, the marketing being done by sending one or more marketing messages based on the interaction with the advertising video game of the selected client.

In yet another embodiment of the present disclosure, a method for marketing one or more clients through one or more video games is provided. The method includes (a) providing a website hosted by the at least one computer containing a microprocessor in communication with the computer network, (b) presenting a list of the one or more companies, brands, products, locations and services on the website, the list being presented to the one or more users for selection by the user, (c) requesting selection of one of the one or more companies, brands, products, locations and services; the selection being requested to a user of the one or more users through the website, (d) presenting at least one video game of the one or more video games on the website, the at least one video game containing advertising corresponding to the selected one or more companies, brands, products, locations and services, (e) providing the one or more users with interaction with at least one video game, the video game being presented to the user for the interaction through the website and (f) marketing the selected client by sending one or more marketing messages or advertisements based on the one or more users interaction with the video game provided through the website.

In yet another embodiment of the present disclosure, a method for marketing the products or services of one or more clients through one or more video games, the marketing being targeted to one or more users by the one or more clients is provided. The method includes (a) providing at least one server containing a microprocessor in communication with a computer network, (b) presenting a list of the one or more clients or products, the list being presented to the one or more users by the at least one server, (c) requesting selection of one of the one or more clients or products by the at least server; the selection being requested to a user of the one or more users, (d) presenting at least one video game of the one or more video games by the at least one server, the at least one video game corresponding to the selected one or more clients or products, (e) providing interaction with one of the at least one video game by the at least one server, the video game being presented to the one or more users for interaction with the one or more users; and (f) marketing the selected client, the marketing being done by sending one or more marketing messages corresponding to the selected client or products by the at least one server.

In yet another embodiment of the present disclosure, the method for marketing the one or more clients through the one or more advertising video games includes presenting a list of the one or more clients, where the list is presented to the one or more users. Further, the method includes requesting selection of one of the one or more clients, where the selection is requested to a user of the one or more users. The method further includes presenting at least one advertising video game of the one or more advertising video games, where the at least one advertising video game corresponds to the selected client. The method further includes providing interaction with one of the at least one advertising video game. Finally, the method includes marketing the selected client, where the marketing is done by sending one or more marketing messages based on the interaction of the user with the advertising video game of the selected client.

In another embodiment of the present disclosure, a system for marketing the one or more clients through the one or more advertising video games is provided. The system includes a first presentation module for presenting a list of the one or more clients, where the list is presented to the one or more users. Further, the system includes a selection module for requesting selection of one of the one or more clients, where the selection is requested to a user of the one or more users. The system further includes a second presentation module for presenting at least one advertising video game of the one or more advertising video games, where the at least one advertising video game corresponds to the selected client. The system further includes a game module for providing interaction with one of the at least one advertising video game. Finally, the system includes a marketing module for marketing the selected client by sending one or more marketing messages based on the interaction of the user with the advertising video game of the selected client.

In yet another embodiment of the present disclosure, a method for presenting advertising related to one or more products, services, brands or locations to one or more users through one or more video games is provided. The method includes (1) presenting a list of the one or more products, services, brands or locations to one or more users, the list being presented to the one or more users on one or more computing devices, (2) requesting selection of one of the one or more products, services, brands or locations; the selection being requested to at least one user of the one or more users, (3) receiving data indicating which of the one or more products, services, brands or locations the at least one user selected (4) presenting at least one video game to the at least one user, (5) providing the at least one user interaction with one of the at least one video game, the video game being presented to the at least one user for the interaction, (6) presenting more than one instance of advertising to the at least one user related directly to the specific products, services, brands or locations selected by the at least one user; based on the interaction of the at least one user with the video game, (7) providing the at least one user with one or more incentives related to the specific products, services, brands or locations selected by the user and receiving data from the at least one user regarding interest in, acceptance or rejection of the one or more incentives provided to the at the at least one user.

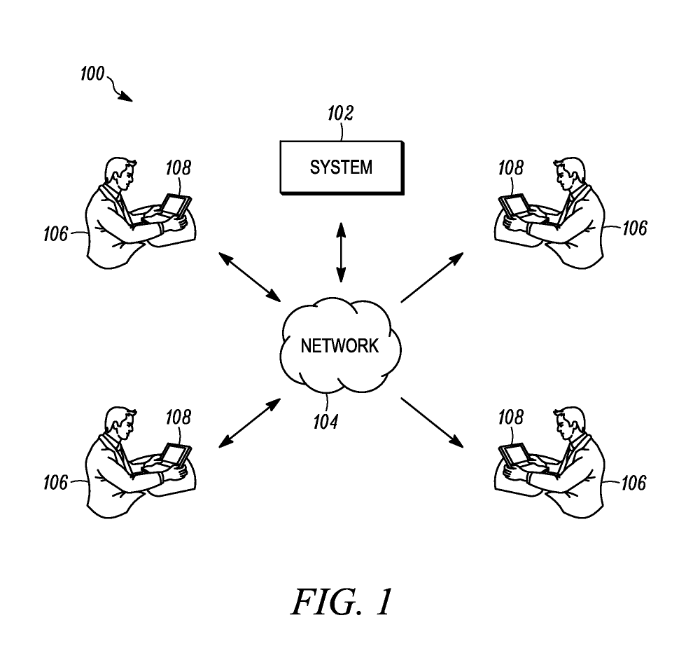

FIG. 1 illustrates an environment 100 in which the various embodiments of the disclosure can be practiced. Environment 100 shows a system 102, a network 104, and one or more users such as a user 106. Further, the figure shows one or more computing device such as a computing device 108. In various embodiment of the present disclosure, the system 102 is hosted on a server. The server can be one or more of a dedicated hosting server and shared hosting server. The system 102 is connected to the one or more computing devices through the network 104. Examples of the network 104 include, but are not limited to, Internet, intranet, WiFi, Bluetooth, infrared, WiMAX, Local Area Network (LAN), GPRS, EDGE, and Virtual Private network (VPN).

According to one of the embodiments of the present disclosure, the network 104 is a conglomeration of connected intranets.

According to another embodiment of the present disclosure, the network 104 is the Internet or, more preferably, an IPV6 compatible internet.

The system 102 provides a user-interface for the user 106, which is accessed through the computing device 108, for requesting one or more operations, where the one or more operations are performed by the system 102. Examples of the one or more operations include, but are not limited to, a display operation, a send operation, and a select operation. Examples of the user-interface include, but are not limited to, a webpage on a website, widget, electronic social network, and blog.

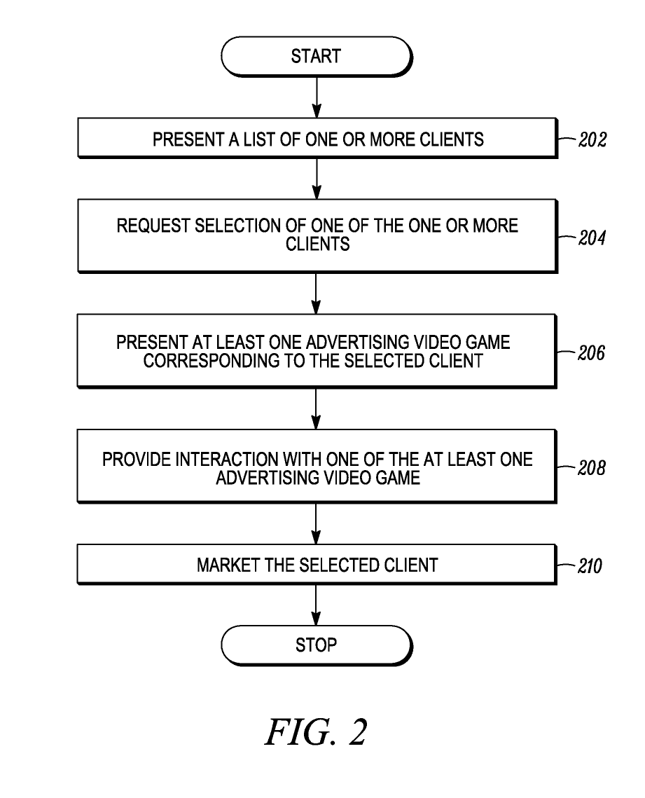

FIG. 2 shows a flowchart for marketing one or more clients through one or more advertising video games, in accordance with an embodiment of the present disclosure. Examples of the one or more advertising games include, but are not limited to, one or more of a sweepstake and a game.

At Step 202, the system 102 presents a list of the one or more clients to the user 106. Examples of the one or more clients include, but are not limited to, a company, a brand, a logo, a product, a symbol, a portion of a product, a rendering or representation of a product, an individual, a location, an item or an entity. At Step 204, selection of one of the one or more clients is requested by the system 102. The selection of the client is requested to the user 106. Subsequently, at step 206, at least one advertising video game of the one or more advertising video games is presented to the user 106. The at least one advertising video game corresponds to the selected client. Thereafter, at step 208, the system 102 provides interaction with one of the at least one advertising video game. The advertising video game is selected by the system 102 based on the input provided by the user 106.

At Step 210, the selected client is marketed by sending one or more marketing messages based on the interaction of the user 106 with the advertising video game of the selected client. Examples of the one or more marketing messages include, but are not limited to, one or more of a discount coupon, merchandise information, an existing offer, advertising material, a logo, a copyright, a trademark, an impression, a product, a character and information about new or existing products. The one or more marketing messages are sent through one or more of a an email, a Short Messaging Service (SMS) message, display on a user-interface, a Multimedia Message (MMS), a phone call and the like.

According to an embodiment of the present disclosure, the one or more marketing messages are delivered to the user 106 during the interaction of the user 106 with the advertising video game. For example, an impression containing information about a new product by the selected client is flashed on the user-interface during the playing of a game corresponding to the selected client by the user 106.

According to another embodiment, the one or more marketing messages are sent to the user 106 after completion of the interaction of the user 106 with the advertising video game. For example, an email is sent to the user 106 about existing offers on products of the selected client.

According to yet another embodiment, one or more rewards are provided to the user 106 when the user 106 completes a task provided by the advertising video game. For example, the user 106 receives a discount coupon on a product of the selected client on winning a game corresponding to the selected client.

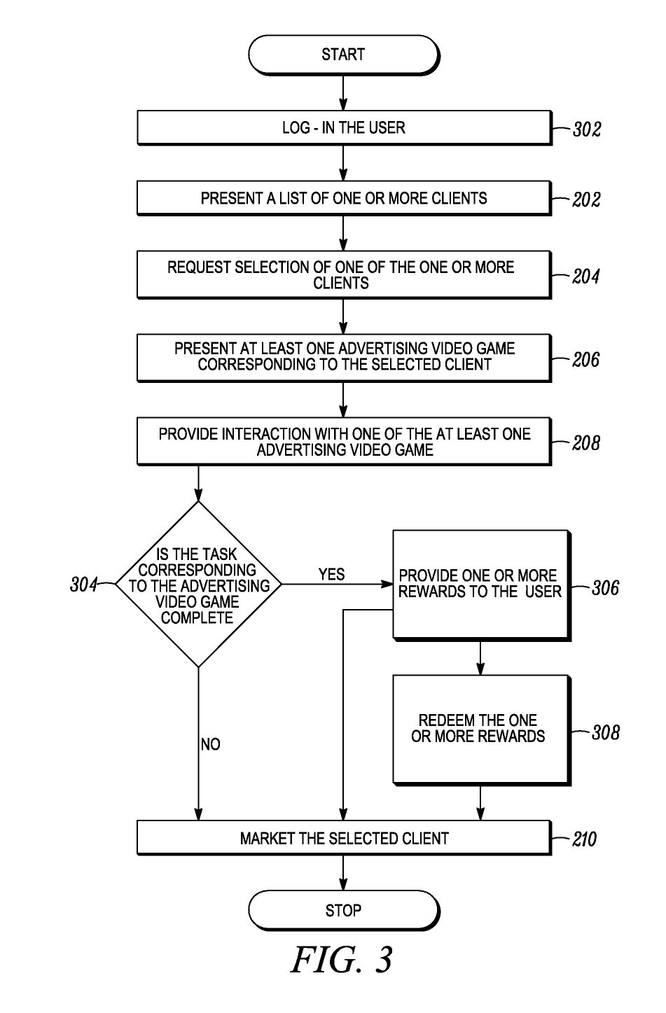

FIG. 3 shows a flowchart for marketing one or more clients through one or more advertising video games, in accordance with another embodiment of the present disclosure. At Step 302, the system 102 logs-in the user 106 through the user-interface provided by the computing device 108.

According to yet another embodiment of the present disclosure, the user 106 has to register with the system 102 before logging-in for the first time. The system 102 registers the user 106 by accepting registration information. The registration information comprises one or more of a name, age, a location, interests and contact details of the user 106. The user 106 provides the registration information through the user-interface provided by the computing device 108. A username and a password are created during the registration of the user 106. The username and the password are required by the system 102 for subsequent logging-in of the user 106.

At Step 202, the system 102 presents the list of the one or more clients to the user 106. Examples of the one or more clients include, but are not limited to, a company, a brand, an individual and an entity. At Step 204, selection of one of the one or more clients is requested by the system 102. The selection of the client is requested to the user 106. Subsequently, at step 206, at least one advertising video game of the one or more advertising video games is presented to the user 106. The at least one advertising video game corresponds to the selected client. Thereafter, at step 208, the system 102 provides interaction with one of the at least one advertising video game. The advertising video game is selected by the system 102 based on the input provided by the user 106.

At Step 304, the system 102 performs a check whether the user 106 completes the task provided by the advertising game.

According to yet another embodiment, the user 106 completes the task; the system 102 provides the user 106 with one or more rewards as shown in the step 306. The one or more rewards being selected from one of a discount coupon, a redemption code and a rebate.

According to yet another embodiment, the user 106 is not able to complete the task; the selected client is marketed by sending one or more marketing messages based on the interaction of the user 106 with the advertising video game of the selected client as shown in the step 210.

According to yet another embodiment of the present disclosure, the system 102 tracks one or more impressions delivered on behalf of the selected client, the one or more impressions constitute the one or more marketing messages.

At step 308, the user 106 redeems the one or more rewards earned at the step 308.

According to yet another embodiment of the present disclosure, the one or more rewards can be redeemed at website of the selected client. The system 102 will provide digital bar codes. The digital bar codes will facilitate the user 106 to redeem the one or more rewards at the website of the selected client.

According to yet another embodiment, the one or more rewards can be accumulated by the user 106 and redeemed afterwards.

According to yet another embodiment of the present disclosure, information of the user 106 is provided to the selected client, the information being gathered from interaction of the user 106 with the advertising video game.

According to still another embodiment of the present disclosure, a blog is provided for interaction of the user 106 with rest of the one or more users, where the blog corresponds to the advertising video game.

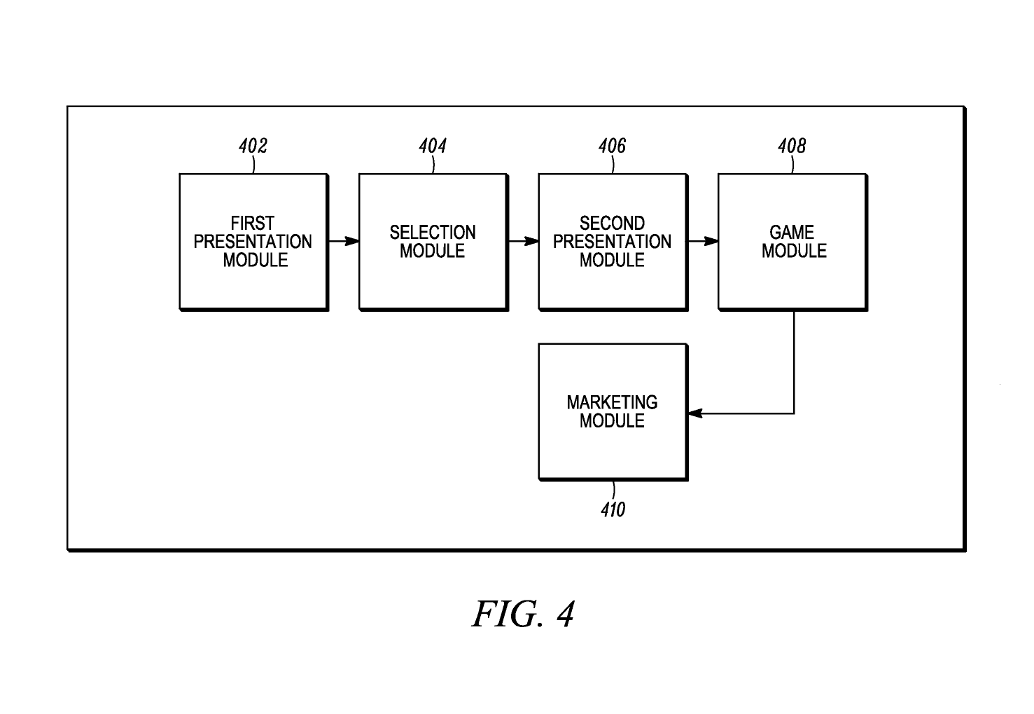

FIG. 4 illustrates the system 102 for marketing one or more clients through one or more advertising video games, in accordance with an embodiment of the present disclosure. The system 102 includes a first presentation module 402, a selection module 404, a second presentation module 406, a game module 408 and a marketing module 410. The first presentation module 402 presents a list of the one or more clients to the user 106. Examples of the one or more clients include, but are not limited to, a company, a brand, an individual and an entity. Subsequently, the selection module 404 requests selection of one of the one or more clients. The selection of the clients is requested to the user 106. Thereafter, the second presentation module 406 presents at least one advertising video game of the one or more advertising video games to the user 106. The at least one advertising video game corresponds to the selected client. The game module 408 provides interaction with one of the at least one advertising video game.

The marketing module 410 markets the selected client, where the selected client is marketed by sending the one or more marketing messages based on the interaction of the user 106 with the advertising video game of the selected client. Examples of the one or more marketing messages include, but are not limited to, one or more of a discount coupon, merchandise information, an existing offer, an advertisement material, a logo, a copyright, a trademark, an impression and information about new products. The one or more marketing messages are sent through one or more of an email, a Short Messaging Service (SMS) message, display on a user-interface, a Multimedia Message (MMS), a phone call and the like.

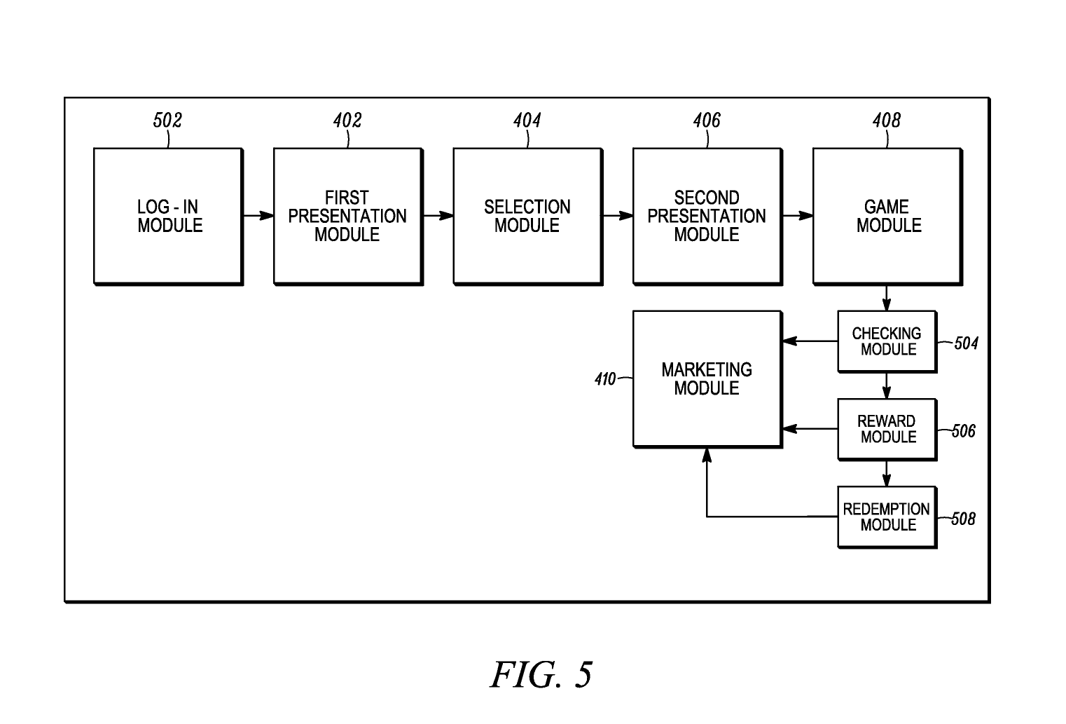

FIG. 5 illustrates the system 102 for marketing one or more clients through one or more advertising video games, in accordance with another embodiment of the present disclosure. The system 102 includes a login module 502, a checking module 504, a reward module 506, a redemption module 508, the first presentation module 402, the selection module 404, the second presentation module 406, the game module 408 and the marketing module 410. The login module 502 logs-in the user 106 through the user-interface provided by the computing device 108.

According to an embodiment of the present disclosure, the system 102 includes a registration module. The registration module registers the user 106 before logging in for the first time. The registration module registers the user 106 by accepting registration information. The registration information comprises one or more of a name, age, a location, interests and contact details of the user 106. The user 106 provides the registration information through the user-interface provided by the computing device 108. A username and a password are created during the registration of the user 106. The username and the password are required by the system 102 for subsequent logging in of the user 102.

The first presentation module 402 presents a list of the one or more clients to the user 106. The selection module 404 requests selection of one of the one or more clients. The selection of the clients is requested to the user 106. The second presentation module 406 presents at least one advertising video game of the one or more advertising video games to the user 106. The at least one advertising video game corresponds to the selected client. The game module 408 provides interaction with one of the at least one advertising video game. Subsequently, the checking module 504 performs a check whether the user 106 completes the task provided by the advertising game.

According to an embodiment, the user 106 completes the task; the reward module 506 provides the user 106 with one or more marketing messages including one or more rewards. The one or more rewards are selected from one of a discount coupon, a redemption code and a rebate.

According to another embodiment, the user 106 is not able to complete the task; the marketing module 410 markets the selected client is marketed by sending one or more marketing messages based on the interaction of the user 106 with the advertising video game of the selected client.

The redemption module 508 facilitates redeeming of the one or more rewards earned at the step 308. The one or more rewards can be redeemed by the user 106.

According to yet another embodiment of the present disclosure, system 102 includes a track module. The track module tracking one or more impressions delivered on behalf of the selected client, the one or more impressions constituting the one or more marketing messages.

According to yet another embodiment of the present disclosure, the system 102 includes a blog module, the blog module providing a blog for interaction of the user 106 with rest of the one or more users, the blog corresponding to the at least one advertising video game.

According to yet another embodiment of the present disclosure, the system 102 includes a storage module, the storage module storing the one or more rewards, the one or more rewards being accumulated until redeemed.

According to yet another embodiment of the present disclosure, the system 102 includes an information module, the information module providing information of the user 106 to the selected client, the information being gathered from interaction of the user with the advertising video game.

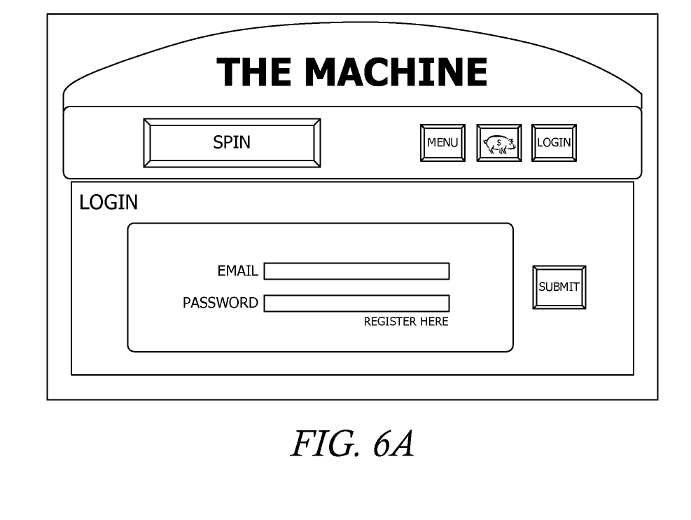

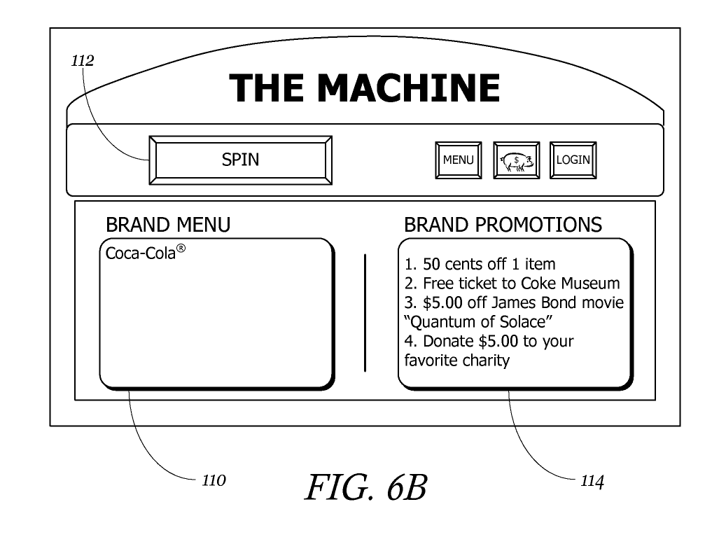

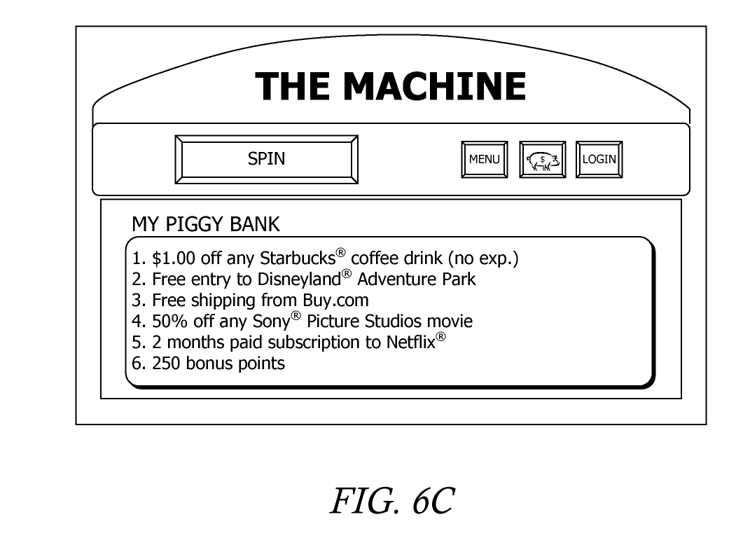

FIGS. 6a, 6b and 6c illustrate an example of the user-interface provided by the system 102 for marketing one or more clients through one or more advertising video games, in accordance with an embodiment of the present disclosure. FIG. 6a shows an exemplary user-interface of an advertising video game. The system 102 logs-in the user 106 before requesting selection of the client and providing interaction with the advertising video game corresponding to the selected client. The login information required is the email address and password created during the registration. In case the user 106 does not have an account, the user is provided with an option of creating a new account through ‘Register here’ link. FIG. 6b shows an exemplary user-interface of the advertising video game after the user 106 logs in. The user 106 is provided with a list of one or more brands to the user 106. When the user selects a brand 110 from the list of various brands, an advertisement of the selected brand is displayed in the ‘brand promotions’ section. Once the user has seen/read the displayed advertisement, the user 106 can then click on the button ‘Spin’ 112, and the advertising video game displays another brand promotion 114 of the selected brand. Each impression of the displayed advertisement is tracked and the user 106 is a provided with a credit for each impression. Further, the user 106 can select a particular brand promotion and use the offer provided in that brand promotion. FIG. 6c shows an exemplary user-interface of the ‘my piggy bank’ section of the user. The ‘my piggy bank’ section displays the rewards and credit points 116 for impressions collected by the user 106. The rewards keep getting accumulated until redeemed or until they expire.

The method and system described above have a number of advantages. The method enables the client to utilize their advertising budget in a more efficient manner. Further, the method provides a more interactive and interesting way of promoting one or more brands to the user. Moreover, the method and system enables the client to keep track of the advertising revenues.

In the foregoing specification, specific embodiments of the present disclosure have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims below.

What is claimed is:

1. A method for presenting advertising related to one or more products, services, brands or locations to one or more users through one or more video games, the method comprising:
a. presenting a list of the one or more products, services, brands or locations to one or more users on one or more visual displays;
b. requesting the one or more users select the one or more products, services, brands or locations using one or more computing devices;
c. receiving data indicating which of the one or more products, services, brands or locations the at least one or more users selected using the one or more computing devices;
d. presenting one or more video games to the one or more users, the video game being presented to the one or more users for the user to interact with the one or more video game;
e. presenting one or more instances of advertising related to the specific products, services, brands or locations selected by the one or more users to one or more users;
f. providing one or more incentives related directly to the specific products, services, brands or locations selected by the one or more users to the one or more users; and
g. receiving data from the one or more users regarding interest in, acceptance or rejection of the one or more incentives provided to the one or more users.

2. The method according to claim 1, wherein the advertising presented includes at least part of or a depiction of the one or more products, services, brands or locations selected by the one or more users and is incorporated into the one or more video games presented to the one or more users.

3. The method according to claim 1, wherein the one or more video games comprises one or more of a sweepstakes and a game.

4. The method according to claim 1, wherein the one or more incentives comprises one or more of a discount coupon, merchandise information, an existing offer, an advertisement material, a logo, a copyright, a trademark, an impression. a discount, a prize, information about new products or services and a link to another website or file which offers one or more of a discount coupon, merchandise information, an existing offer, an advertisement material, a logo, a copyright, a trademark, an impression, a discount and a prize, information about new products or services.

5. The method according to claim 4, wherein the one or more incentives are sent through one or more of a hyperlink, a webpage, an email, a short messaging service (SMS) message, a barcode, a Multimedia Message (MMS), a visual display, a computing device and a phone call.

6. The method according to claim 1, further comprising providing a blog on a server for interaction of the one or more users with the other one or more users, the blog containing one or more instances of advertising directly related to one or more products, services, brands or locations selected by the one or more users.

7. The method according to claim 1, further comprising tracking the one or more instances of advertising presented to the one or more users and presenting new or additional instances of advertizing based on data from the one or more users regarding interest in, acceptance or rejection of the one or more incentives provided to the one or more users.

8. The method according to claim 1, wherein the one or more incentives related directly to the specific products, services, brands or locations selected by the one or more users receiving the incentive is provided upon the one or more users completing a task provided by the video game, the one or more incentives being selected from one of a group of discount coupon, a redemption code and a rebate.

9. The method according to claim 8, further comprising storing the one or more incentives on a storage medium and allowing the one or more users access to the stored incentives and accumulate the stored incentives until the incentives are redeemed or expired.

10. The method according to claim 8, wherein the one or more incentives are redeemed at website or store location of the company or group providing the specific products, services or brands selected by the one or more users.

11. The method according to claim 1, further comprising providing information of the user to the selected client, the information being gathered from interaction of the user with the advertising video games.

12. The method according to claim 1, further comprising requesting that the one or more users create an account having a username and password prior to providing one or more incentives to the one or more users.

13. A system for marketing one or more clients through one or more video games containing advertising related to the one or more clients, the marketing being targeted to one or more users of the one or more video games by the one or more clients, the system comprising:
a. at least one computer server having an interface for communication over a computer network;
b. a first presentation module, the first presentation module presenting a list of at least one of the one or more clients and products, services and brands associated with the one or more clients, the list being presented to one or more users of the one or more video games;
c. a selection module, the selection module requesting selection of at least one of the one or more clients and products, services and brands associated with the one or more clients and receiving data regarding the of at least one of the one or more clients and products, services and brands associated with the one or more clients selected by the one or more users, the selection being requested to the one or more users of the one or more video games;
d. a second presentation module, the second presentation module presenting the one or more video games containing one or more advertisements related to the one or more clients and products, services and brands associated with the one or more clients selected by the one or more users;
e. a game module, the game module providing the one or more users with interaction with the one or more video games, the one or more video games being presented to the one or more users for interaction with the one or more users; and
f. a marketing module, the marketing module marketing the selected client by sending one or more marketing messages to the one or more users.

14. The system according to claim 13, further comprising a login module, the log-in module logging-in the one or more users.

15. The system according to claim 13, further comprising a reward module, the reward module providing one or more rewards to the one or more users upon completing a task provided by the at least one video game, the one or more rewards being selected from one of a discount coupon, a redemption code and a rebate.

16. The system according to claim 13, further comprising a track module, the track module tracking the one or more advertisements delivered on behalf of the selected client, the one or more impressions constituting the one or more marketing messages.

17. The system according to claim 13, further comprising an information module, the information module providing information of the user to the selected client, the information being gathered from interaction of the user with the advertising video game.

18. A computer program product for use with a computer, said computer program product comprising:
a computer usable medium having computer readable program code embodied therein for marketing one or more clients through one or more video games containing advertisements related to the one or more clients, the marketing being targeted to one or more users by the one or more clients, the one or more video games being one or more interactive media facilitating the marketing, the computer program code:
a. presenting a list of at least one of a list of one or more clients and products, services and brands associated with the one or more clients, the list being presented to the one or more users;
b. requesting selection of at least one of the products, services and brands associated with the one or more clients; the selection being requested to at least one of the one or more users;
c. presenting at least one video game of the one or more video games to the one or more users, the at least one video game containing advertising images related or corresponding to the at least one clients and products, services and brands associated with the one or more clients ;
d. providing interaction with one of the at least one advertising video game, the advertising video game being presented to the user for the interaction, and
e. marketing the selected client, the marketing being done by sending one or more marketing messages based on the interaction with the advertising video game of the selected client.

19. A method for marketing one or more clients through one or more video games, the method comprising:
a. providing a website hosted by the at least one computer containing a microprocessor in communication with the computer network
b. presenting a list of the one or more companies, brands, products, locations and services on the website, the list being presented to the one or more users for selection by the user;
c. requesting selection of one of the one or more companies, brands, products, locations and services; the selection being requested to a user of the one or more users through the website;
d. presenting at least one video game of the one or more video games on the website, the at least one video game containing advertising corresponding to the selected one or more companies, brands, products, locations and services;
e. providing the one or more users with interaction with at least one video game, the video game being presented to the user for the interaction through the website; and
f. marketing the selected client by sending one or more marketing messages or advertisements based on the one or more users interaction with the video game provided through the website.

20. A method for marketing the products or services of one or more clients through one or more video games, the marketing being targeted to one or more users by the one or more clients, the method comprising:
a. providing at least one server containing a microprocessor in communication with a computer network;
b. presenting a list of the one or more clients or products, the list being presented to the one or more users by the at least one server;
c. requesting selection of one of the one or more clients or products by the at least server; the selection being requested to a user of the one or more users;
d. presenting at least one video game of the one or more video games by the at least one server, the at least one video game corresponding to the selected one or more clients or products;
e. providing interaction with one of the at least one video game by the at least one server, the video game being presented to the one or more users for interaction with the one or more users; and
f. marketing the selected client, the marketing being done by sending one or more marketing messages corresponding to the selected client or products by the at least one server.
